(19) United States
(12) Patent Application Publication
(10) Pub. No.: US 2016/0283047 A1
(43) Pub. Date: Sep. 29, 2016

(54) LOGIN INTERFACE DISPLAYING METHOD AND APPARATUS

(71) Applicant: TENCENT TECHNOLOGY (SHENZHEN) COMPANY LIMITED, Shenzhen (CN)

(72) Inventor: ZIFENG SHANG, Shenzhen (CN)

(73) Assignee: TENCENT TECHNOLOGY (SHENZHEN) COMPANY LIMITED

(21) Appl. No.: 15/179,673

(22) Filed: Jun. 10, 2016

Related U.S. Application Data
(63) Continuation of application No. PCT/CN2015/072298, filed on Feb. 5, 2015.

(30) Foreign Application Priority Data
Feb. 19, 2014 (CN) 2014-10056992.X

(51) Int. Cl. G06F 3/0481; G06F 17/21; G06F 21/36; G06F 17/24

(52) U.S. Cl. CPC G06F 3/0481; G06F 17/243; G06F 17/211; G06F 21/36

(57) ABSTRACT

The present disclosure discloses a login interface displaying method and apparatus, and belongs to the field of Internet technologies. The method includes: obtaining a login entry identifier of a specified login entry in a current network application; obtaining an interface drawing resource corresponding to the login entry identifier; and drawing a login interface of the specified login entry according to the interface drawing resource corresponding to the login entry identifier. The apparatus includes: a first obtaining module, a second obtaining module, and a drawing module. In the present disclosure, an interface drawing resource corresponding to a login entry identifier of a specified login entry is obtained, and a login interface of the specified login entry is drawn according to the obtained interface drawing resource.

### CROSS-REFERENCES TO RELATED APPLICATIONS

This application is a continuation application of PCT Patent Application No. PCT/CN2015/072298, filed on Feb. 5, 2015, which claims priority to Chinese Patent Application No. 201410056992.X, entitled “LOGIN INTERFACE DISPLAYING METHOD AND APPARATUS” filed on Feb. 19, 2014, the entire contents of both of which are incorporated herein by reference.

### FIELD OF THE TECHNOLOGY

The present disclosure relates to the field of Internet technologies, and more particularly to a login interface displaying method and apparatus.

### BACKGROUND OF THE DISCLOSURE

With the continuous development of current Internet technologies, more and more people use network applications. Because login is often required when a network application is used, at login of a user, a corresponding login interface is generally displayed by a terminal, and the user inputs personal information into the login interface to perform login. Different login interface displaying methods bring about different operating experiences to the user. Therefore, a reasonable login interface displaying method needs to be selected.

A login interface displaying method is provided in the related technology. In the method, a network application contains at least one login entry, a default interface drawing resource is set for all login entries in advance, and a login interface is displayed according to the default interface drawing resource when it is detected that a user clicks any of the login entries.

However, different login entries usually correspond to different functions in the same network application, but a login interface always needs to be displayed according to the default interface drawing resource when it is detected that the user clicks any of the login entries. As a result, the login interface is presented in a single form, thereby causing an undesirable operating experience of the user at login.

### SUMMARY

In one aspect, a login interface displaying method is provided, the method including: obtaining a login entry identifier of a specified login entry in a current network application, the network application containing at least one login entry, and each login entry corresponding to one function in the network application; obtaining an interface drawing resource corresponding to the login entry identifier, each login entry identifier corresponding to one interface drawing resource, and the interface drawing resource corresponding to each login entry identifier being used to describe a function corresponding to a login entry identified by the login entry identifier; and drawing a login interface of the specified login entry according to the interface drawing resource corresponding to the login entry identifier.

In another aspect, a login interface displaying apparatus is provided, the apparatus including: a first obtaining module, configured to obtain a login entry identifier of a specified login entry in a current network application, the network application containing at least one login entry, and each login entry corresponding to one function in the network application; a second obtaining module, configured to obtain an interface drawing resource corresponding to the login entry identifier, each login entry identifier corresponding to one interface drawing resource, and the interface drawing resource corresponding to each login entry identifier being used to describe a function corresponding to a login entry identified by the login entry identifier; and a drawing module, configured to draw a login interface of the specified login entry according to the interface drawing resource corresponding to the login entry identifier.

### BRIEF DESCRIPTION OF THE DRAWINGS

To describe the technical solutions of the embodiments of the present invention more clearly, the accompanying drawings for illustrating the embodiments will be introduced briefly in the following. Apparently, the drawings in the following description are only some embodiments of the present invention, and a person of ordinary skill in the art may obtain other drawings based on these accompanying drawings without creative efforts.

FIG. 1 is a flowchart of a login interface displaying method according to embodiment 1 of the present invention;

FIG. 2 is a flowchart of a login interface displaying method according to embodiment 2 of the present invention;

FIG. 3 is a schematic interface diagram of a first login interface according to embodiment 2 of the present invention;

FIG. 4 is a schematic interface diagram of a second login interface according to embodiment 2 of the present invention;

FIG. 5 is a schematic interface diagram of a third login interface according to embodiment 2 of the present invention;

FIG. 6 is a schematic interface diagram of a fourth login interface according to embodiment 2 of the present invention;

FIG. 7 is a schematic structural diagram of a login interface displaying apparatus according to embodiment 3 of the present invention; and

FIG. 8 is a schematic structural diagram of a terminal according to embodiment 4 of the present invention.

### DESCRIPTION OF EMBODIMENTS

In order to make the objectives, technical solutions, and advantages of the present disclosure more comprehensible, the implementation manners of the present disclosure will be described in further detail below with reference to the accompanying drawings.

### Embodiment 1

Different login entries usually correspond to different functions in the same network application, but during login interface displaying in the existing related technology, a login interface always needs to be displayed according to a default interface drawing resource if it is detected that a user clicks any of the login entries. As a result, the login interface is presented in a single form, thereby causing an undesirable operating experience of the user at login.

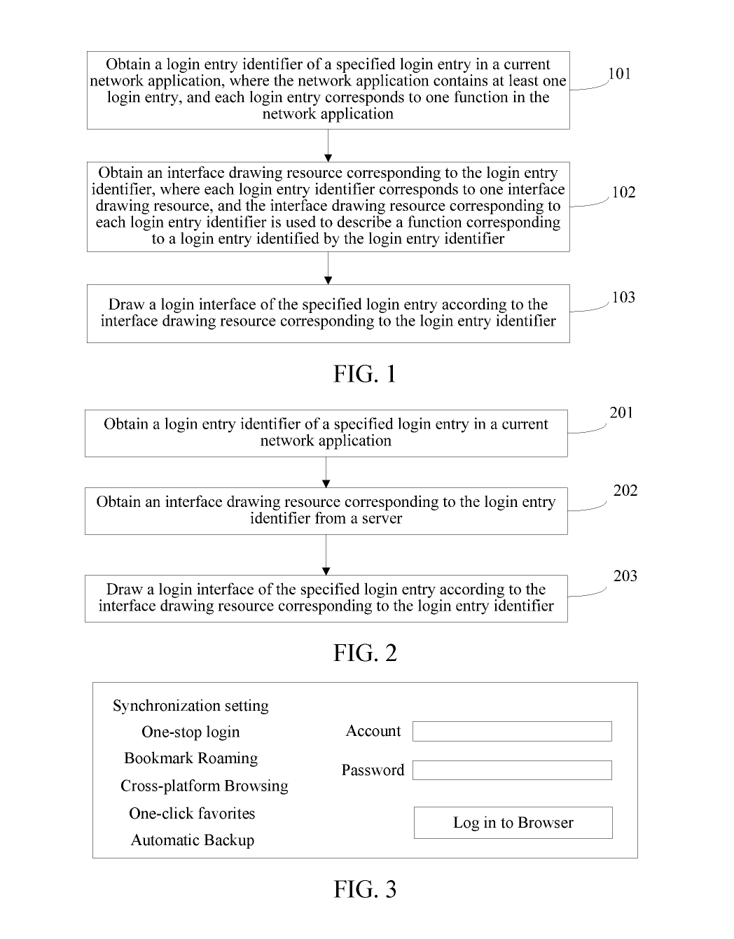

In order to improve the operating experience of the user at login, this embodiment of the present invention provides a login interface displaying method. The method may be applied to a terminal. The terminal includes, but is not limited to, a mobile phone, a computer, a tablet computer, and so on. Referring to FIG. 1, the process of the method provided in this embodiment includes the following steps.

101: Obtaining a login entry identifier of a specified login entry in a current network application, where the network application contains at least one login entry, and each login entry corresponds to one function in the network application.

102: Obtaining an interface drawing resource corresponding to the login entry identifier, where each login entry identifier corresponds to one interface drawing resource, and the interface drawing resource corresponding to each login entry identifier is used to describe a function corresponding to a login entry identified by the login entry identifier.

The obtaining an interface drawing resource corresponding to the login entry identifier includes, but is not limited to: obtaining the interface drawing resource corresponding to the login entry identifier from local storage, or obtaining the interface drawing resource corresponding to the login entry identifier from a server.

The obtaining an interface drawing resource corresponding to the login entry identifier includes: determining whether the interface drawing resource corresponding to the login entry identifier is stored locally; and performing the step of obtaining the interface drawing resource corresponding to the login entry identifier from a server if the interface drawing resource corresponding to the login entry identifier is not stored locally.

After the determining whether the interface drawing resource corresponding to the login entry identifier is stored locally, the method further includes: obtaining the interface drawing resource corresponding to the login entry identifier locally if the interface drawing resource corresponding to the login entry identifier is stored locally.

Before the obtaining the interface drawing resource corresponding to the login entry identifier from a server, the method further includes: obtaining a default interface drawing resource that is stored locally; and drawing a login interface corresponding to the specified login entry according to the default interface drawing resource, and after the interface drawing resource corresponding to the login entry identifier is downloaded, performing the step of drawing a login interface of the specified login entry according to the interface drawing resource corresponding to the login entry identifier.

After the obtaining the interface drawing resource corresponding to the login entry identifier from a server, the method further includes: storing locally the interface drawing resource corresponding to the login entry identifier.

103: Drawing a login interface of the specified login entry according to the interface drawing resource corresponding to the login entry identifier.

In the method provided in this embodiment, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

### Embodiment 2

This embodiment of the present invention provides a login interface displaying method. The method provided in this embodiment is exemplified with reference to the content of the foregoing embodiment 1. Referring to FIG. 2, the process of the method provided in this embodiment includes the following steps.

201: Obtaining a login entry identifier of a specified login entry in a current network application.

The current network application contains at least one login entry, and the number of the login entries in the current network application is not specifically limited in this embodiment. Each login entry corresponds to one function in the current network application, each login entry also corresponds to one login entry identifier, and the login entry identifier is used to identify the corresponding login entry. If any of the functions in the current network application has a corresponding login entry, there is at least one login entry corresponding to the function, and the number of the login entries corresponding to any of the functions in the current network application is not specifically limited in this embodiment.

The manner of obtaining the login entry identifier of the specified login entry in the current network application is also not specifically limited in this embodiment, and includes, but is not limited to: detecting an operation of clicking, by a user, a login entry in the current network application, using the detected login entry clicked by the user as the specified login entry, and obtaining the login entry identifier of the specified login entry.

For example, there are three functions in the current network application, and the three functions correspond to three login entries, which are LogEntry1, LogEntry2, and LogEntry3, respectively. A login interface identifier corresponding to LogEntry1 is ID1, a login interface identifier corresponding to LogEntry2 is ID2, and a login interface identifier corresponding to LogEntry3 is ID3. When it is detected that the login entry clicked by the user is LogEntry1, LogEntry1 is used as the specified login entry, and the login entry identifier ID1 of the login entry LogEntry1 is obtained.

202: Obtaining an interface drawing resource corresponding to the login entry identifier from a server.

Different login entry identifiers correspond to different interface drawing resources, and the interface drawing resource corresponding to each login entry identifier is used to describe a function corresponding to a login entry identified by each login entry identifier. The interface drawing resource may contain a picture, a text, and other content, and the content contained in the interface drawing resource corresponding to each login entry identifier is not specifically limited in this embodiment.

The obtaining manner of obtaining the interface drawing resource corresponding to the login entry identifier from the server is also not specifically limited in this embodiment, and includes, but is not limited to: sending an interface drawing resource obtaining request to the server, where the interface drawing resource obtaining request at least contains the login entry identifier, and receiving the interface drawing resource returned by the server according to the login entry identifier in the interface drawing resource obtaining request. Certainly, the interface drawing resource obtaining request may further contain other content, such as specific parameters of the interface drawing resource that is obtained by request, which is not specifically limited in this embodiment.

The server may store locally different login entries and their corresponding interface drawing resources in advance, and when receiving the interface drawing resource obtaining request sent by the terminal, the server may perform search locally according to the login entry identifier in the interface drawing resource obtaining request, and find and return a corresponding interface drawing resource to the terminal. The search manner of searching, by the server, for the corresponding interface drawing resource according to the login entry identifier in the interface drawing resource obtaining request is not specifically limited in this embodiment.

Furthermore, since the obtaining process consumes a lot of time, an interface drawing resource corresponding to a login entry identifier may be stored locally each time after the interface drawing resource corresponding to the login entry identifier is obtained from the server, so as to avoid re-obtaining the interface drawing resource next time, which is not specifically limited in this embodiment. Accordingly, in the method provided in this embodiment, before the interface drawing resource corresponding to the login entry identifier is obtained from the server, first, it is determined whether the interface drawing resource corresponding to the login entry identifier is stored locally, and then, the step of obtaining the interface drawing resource corresponding to the login entry identifier from the server is performed if the interface drawing resource corresponding to the login entry identifier is not stored locally.

The determining manner of determining whether the interface drawing resource corresponding to the login entry identifier is stored locally is not specifically limited in this embodiment, and includes, but is not limited to: after obtaining the login entry identifier of the specified login entry in the current network application, performing search locally according to the obtained login entry identifier, and if the interface drawing resource corresponding to the login entry identifier is found, determining that the interface drawing resource corresponding to the login entry identifier is stored locally; or otherwise, determining that the interface drawing resource corresponding to the login entry identifier is not stored locally.

After it is determined whether the interface drawing resource corresponding to the login entry identifier is stored locally, the interface drawing resource corresponding to the login entry identifier is obtained directly from local storage if it is determined that the interface drawing resource corresponding to the login entry identifier is stored locally.

For example, the terminal already stores locally the login entry identifier ID1 and a corresponding interface drawing resource thereof. Before the interface drawing resource corresponding to the login entry identifier ID1 is obtained from the server, first, it is determined whether the interface drawing resource corresponding to the login entry identifier ID1 is stored locally, it can be determined by means of search that the interface drawing resource corresponding to the login entry identifier ID1 is stored locally, and then the interface drawing resource corresponding to the login entry identifier ID1 is obtained directly from local storage.

For another example, the terminal does not store locally the login entry identifier ID1 and a corresponding interface drawing resource thereof. Before the interface drawing resource corresponding to the login entry identifier ID2 is obtained from the server, first, it is determined whether the interface drawing resource corresponding to the login entry identifier ID2 is stored locally, it can be determined by means of search that the interface drawing resource corresponding to the login entry identifier ID2 is not stored locally, then an interface drawing resource obtaining request is sent to the server, where the interface drawing resource obtaining request at least contains the login entry identifier ID2, and the interface drawing resource returned by the server according to the login entry identifier ID2 in the interface drawing resource obtaining request is received. Besides, after the interface drawing resource corresponding to the login entry identifier ID2 is obtained, the login entry identifier ID2 and the corresponding interface drawing resource thereof may be stored locally.

Besides, since the obtaining process needs to consume some time, the user may perceive a delay in the login interface displaying process. In order to reduce the perception of the user about the delay, in the method provided in this embodiment, before the interface drawing resource corresponding to the login entry identifier is obtained from the server, a default interface drawing resource that is stored locally is obtained; and a login interface corresponding to a specified login entry is drawn according to the default interface drawing resource, and after the interface drawing resource corresponding to the login entry identifier is obtained from the server, step 203 is performed. Since the default interface drawing resource that is stored locally is obtained quickly, the login interface can be displayed quickly, thereby reducing the perception of the user about the delay. Certainly, the perception of the user about the delay generated in the obtaining process may be further reduced in other manners, which are not specifically limited in this embodiment.

Furthermore, when the interface drawing resource corresponding to the login entry identifier is obtained from the server, the default obtaining manner is a synchronous obtaining manner, and in the synchronous obtaining manner, all operations are performed by a main thread, namely, when the main thread proceeds to the obtaining step, subsequent operations can be performed only when the obtaining is completed, so that the main thread cannot proceed to subsequent operations while being always stopped at the obtaining step if the obtaining consumes too much time. Therefore, the obtaining efficiency is low. In order to improve the obtaining efficiency, an asynchronous obtaining manner is employed in this embodiment. The implementation method of asynchronous obtaining includes, but is not limited to: when the main thread proceeds to the obtaining step, creating an obtaining thread, performing the obtaining operation by the obtaining thread, continuing with subsequent operations by the main thread, after the obtaining thread completes obtaining, returning the obtained interface drawing resource corresponding to the login entry identifier to the main thread, and invoking the interface drawing resource by the main thread. Certainly, other methods may be further used to improve the obtaining efficiency of obtaining the interface drawing resource corresponding to the login entry identifier from the server, and are not specifically limited in this embodiment.

203: Drawing a login interface of the specified login entry according to the interface drawing resource corresponding to the login entry identifier.

For example, all login interfaces may have a relatively uniform layout. That is, a login interface may include universal interface elements (e.g., frame, user name input box, password input box), and specific interface elements (e.g., text element and/or image element containing information about the specific function corresponding to the login entry identifier). The drawing resource of the universal interface elements may be stored locally. The drawing resource of the specific interface elements may be obtained from the server. When implementing the asynchronous obtaining manner, the browser (e.g., main thread) may draw the universal interface elements in the login interface based on the local interface drawing resource first (e.g., when the obtaining thread does not return result within a time period), and draw the specific interface elements when the obtaining thread retrieves the interface drawing resource from the server.

The drawing manner of drawing the login interface of the specified login entry according to the interface drawing resource corresponding to the login entry identifier is not specifically limited in this embodiment, and includes, but is not limited to: invoking a Create Interface function, using the interface drawing resource corresponding to the login entry identifier as a parameter of the Create Interface function, and drawing, by the Create Interface function, the login interface of the specified login entry according to a configuration parameter of an interface, a configuration parameter of a control, and configuration parameters of a picture and a text to be displayed that are in the interface drawing resource. The configuration parameters in the interface drawing resource may include a size of the interface, positions at which the picture and the text are displayed, and so on, which are not specifically limited in this embodiment.

It should be noted that during construction of interface drawing resources corresponding to different functions, a corresponding interface drawing resource may be constructed purposefully according to a relevant function in the current network application. For example, when a function in the current network application needs to be propagandized, an interface drawing resource corresponding to the function may contain text content for embodying advantages of the function. Certainly, the interface drawing resource may be further constructed in other manners, which are not specifically limited in this embodiment.

For example, the current network application is a browser, and login interfaces corresponding to different functions in the browser are shown in FIG. 3 to FIG. 6. The browser may include various menu options and plug-in buttons. In response to a selection instruction of different menu options or plug-ins related to different functions, the browser may implement the disclosed method to display different login interfaces corresponding to the selected menu option or plug-in for accessing the related function. The login credentials are corresponded to a user account with the browser. In other words, with one user account, same login credentials are used in different login interfaces to access different functions of the browser. In some embodiments, when the login credentials entered by the user in one of the login interfaces corresponding to one function are validated, the user may access other functions of the browser without login again.

In one embodiment, a user may select a “login to the browser” menu option for logging to the user's browser account. In response to the user selection, the browser may present a login interface as shown in FIG. 3, which is a login interface corresponding to the browser. The login interface may present input controls for the user to enter login credentials for the browser account, such as a user name input box, a password input box, a confirmation button for sending the user credentials, etc. Further, the login interface may present information that emphasizes relevant functions and features of the browser. For example, these relevant functions and features may be presented by texts, pictures, animation, and other media formats.

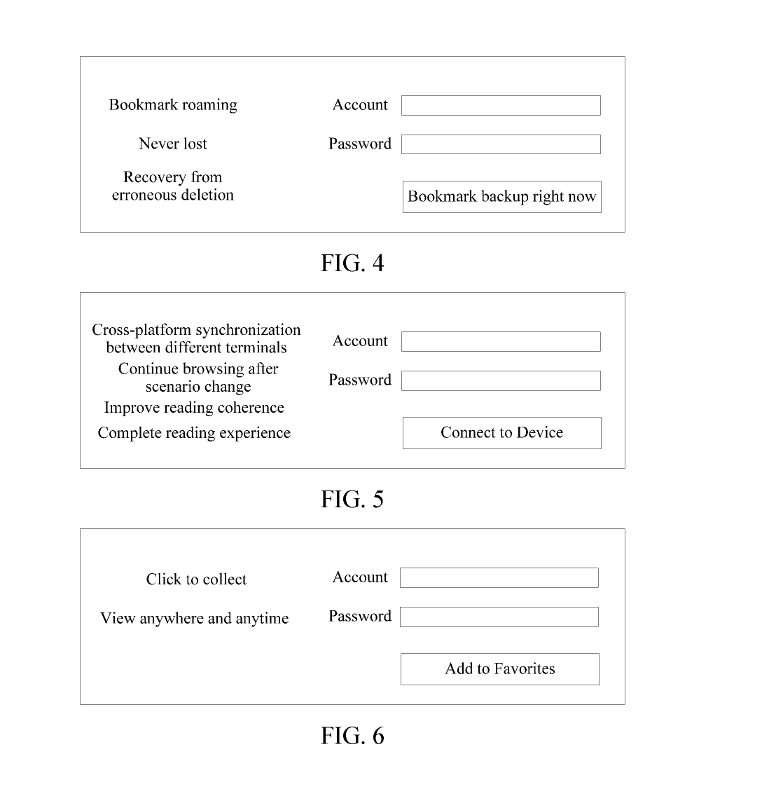

In another embodiment, the user may select a “online bookmarks” menu option for accessing online bookmarks through the browser account. In response to the user selection, the browser may display a login interface as shown in FIG. 4, which is a login interface corresponding to a bookmark function in the browser. The login interface may present input controls for the user to enter login credentials for the browser account, and the login interface may further present information that emphasizes several advantages of the bookmark function. When the user is authenticated through the login interface, the browser may directly take the user to a user interface that allows the user to access the bookmark functions.

In another embodiment, the user may select a “cross-platform browsing” button in a plug-in bar on the browser for accessing a cross-platform browsing function through the browser account. In response to the user selection, the browser may display a login interface as shown in FIG. 5 corresponding to a cross-platform synchronization function in the browser between a personal computer and a mobile terminal or among all devices (e.g., PC, tablet, phone) that has logged in with the browser account. The login interface may present both login input controls and information that expresses application scenarios and characteristics of the cross-platform synchronization function.

In another embodiment, the user may select a “one-click favorites” button in a plug-in bar on the browser for accessing a read-it-later service through the browser account. In response to the user selection, the browser may display a login interface in FIG. 6 corresponding to an article collection function in the browser shared by multiple terminals. The login interface may present both login input controls and information that emphasizes features of the article collection function shared by multiple terminals. The content displayed on the login interfaces in FIG. 3 to FIG. 6 can propagandize the corresponding functions desirably, and the login interfaces corresponding to different functions display different content and are displayed in different forms, thereby providing a desirable operating experience for a user at login.

For ease of understanding, the login interface displaying process is explained using FIG. 4 as an example. A login entry identifier of a specified login entry in a current browser is obtained, where the specified login entry in the current browser is a login entry LogEntry2 corresponding to an Add Bookmark function (e.g., triggered when an “Add Bookmark” button in the browser is selected), and a login entry identifier ID1 of the login entry LogEntry2 corresponding to the Add Bookmark function is obtained. It is determined whether an interface drawing resource corresponding to the login entry identifier ID1 is stored locally. The interface drawing resource corresponding to the login entry identifier ID1 is obtained directly from local storage if the interface drawing resource corresponding to the login entry identifier ID1 is already stored locally. A request for obtaining the interface drawing resource corresponding to the login entry identifier ID1 is sent to a server if the interface drawing resource corresponding to the login entry identifier ID1 is not stored locally, where the request carries the login entry identifier ID1. After receiving the obtaining request, the server searches for the corresponding interface drawing resource according to the login entry identifier ID1 in the request, and finds and sends the corresponding interface drawing resource to a terminal, and the terminal receives the corresponding interface drawing resource. After receiving the interface drawing resource corresponding to the login entry identifier ID1, the terminal draws a login interface of the login entry corresponding to the Add Bookmark function according to the received interface drawing resource, and finally, the login interface is displayed on a screen of the terminal. The style of the login interface may be shown in FIG. 4. In addition to a login account input box and a login button that are necessary, several advantages of the Add Bookmark function are displayed on the left of the interface. In this way, not only can the Add Bookmark function be propagandized, but also the user can be reminded of favorable factors contained by the Add Bookmark function, so that the user can use the Add Bookmark function conveniently.

In another embodiment, the labels of browser functions listed in the login interface in response to a browser login instruction (e.g., as shown in FIG. 3) may provide another way for accessing the listed functions. In other words, these listed labels may be selectable and linked to login entry identifiers of their respective corresponding functions. For example, when the user selects one of the labels (e.g., cross-platform browsing), the browser may obtain the login entry identifier linked to the label, obtain the interface drawing resource corresponding to the login entry identifier and display the login interface corresponding to the function represented by the selected label (e.g., a login interface as shown in FIG. 5).

In the method provided in this embodiment, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

### Embodiment 3

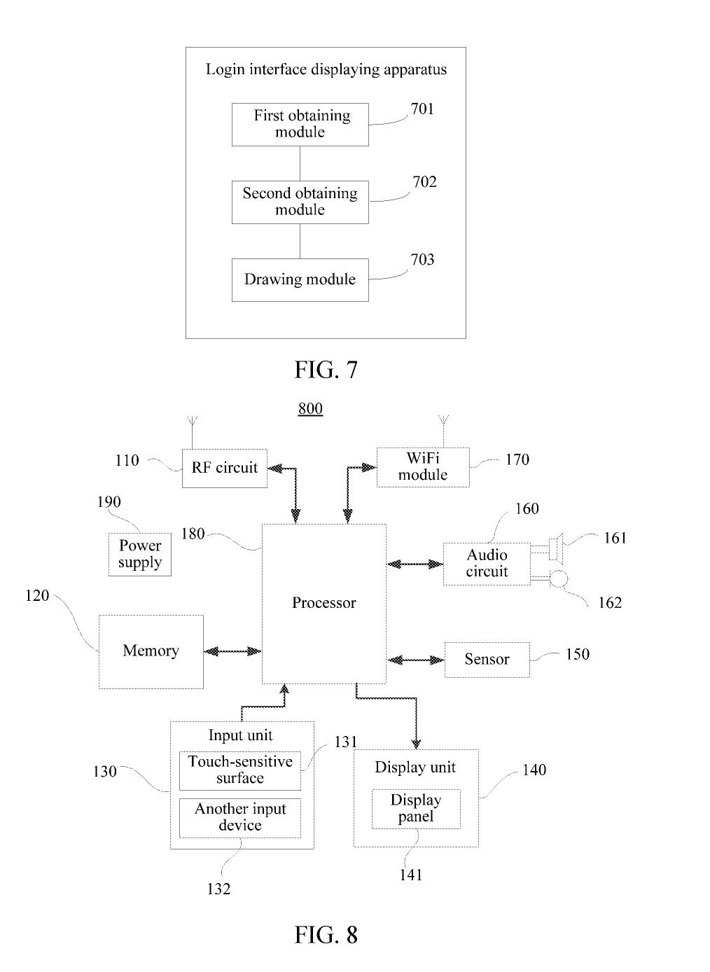

This embodiment of the present invention provides a login interface displaying apparatus. The apparatus is configured to perform the login interface displaying method provided in the foregoing embodiment 1 or embodiment 2. Referring to FIG. 7, the apparatus includes: a first obtaining module 701, configured to obtain a login entry identifier of a specified login entry in a current network application, where the network application contains at least one login entry, and each login entry corresponds to one function in the network application; a second obtaining module 702, configured to obtain an interface drawing resource corresponding to the login entry identifier, where each login entry identifier corresponds to one interface drawing resource, and the interface drawing resource corresponding to each login entry identifier is used to describe a function corresponding to a login entry identified by the login entry identifier; and a drawing module 703, configured to draw a login interface of the specified login entry according to the interface drawing resource corresponding to the login entry identifier.

As a preferred embodiment, the second obtaining module 702 includes: an obtaining unit, configured to obtain the interface drawing resource corresponding to the login entry identifier from local storage, or obtain the interface drawing resource corresponding to the login entry identifier from a server.

As a preferred embodiment, the second obtaining module 702 further includes: a determining unit, configured to determine whether the interface drawing resource corresponding to the login entry identifier is stored locally. The second obtaining module 702 may further include a downloading unit, configured to perform the step of obtaining the interface drawing resource corresponding to the login entry identifier from a server if the interface drawing resource corresponding to the login entry identifier is not stored locally.

As a preferred embodiment, the second obtaining module 702 further includes: a first obtaining unit, configured to obtain the interface drawing resource corresponding to the login entry identifier from local storage if the interface drawing resource corresponding to the login entry identifier is stored locally.

As a preferred embodiment, the second obtaining module 702 further includes: a second obtaining unit, configured to obtain a default interface drawing resource that is stored locally. Further, the drawing module 703 may be configured to draw a login interface corresponding to the specified login entry according to the default interface drawing resource, and after the interface drawing resource corresponding to the login entry identifier is downloaded, perform the step of drawing the login interface of the specified login entry according to the interface drawing resource corresponding to the login entry identifier.

As a preferred embodiment, the second obtaining module 702 further includes: a storing unit, configured to store locally the interface drawing resource corresponding to the login entry identifier.

In the apparatus provided in this embodiment, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

### Embodiment 4

This embodiment provides a terminal. The terminal may be configured to perform the login interface displaying method in the foregoing embodiments. Referring to FIG. 8, the terminal 800 includes:

The terminal 800 may include components such as a radio frequency (RF) circuit 110, a memory 120 including one or more computer readable storage media, an input unit 130, a display unit 140, a sensor 150, an audio circuit 160, a Wireless Fidelity (WiFi) module 170, a processor 180 including one or more processing cores, and a power supply 190. A person skilled in the art may understand that the structure of the terminal shown in FIG. 8 does not constitute a limitation to the terminal, and the terminal may include more components or fewer components than those shown in the figure, or some components may be combined, or a different component deployment may be used.

The RF circuit 110 may be configured to receive and send a signal during an information receiving and sending process or a conversation process. Specifically, the RF circuit 110 may be configured to receive and send a signal during an information receiving and sending process or a conversation process. Specifically, the RF circuit receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 800, and the like. In addition, the memory 120 may include a high speed random access memory, and may also include a non-volatile memory, such as at least one magnetic disk storage device, a flash memory, or another volatile solid storage device. Accordingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and another input device 132. The touch-sensitive surface 131 may also be referred to as a touch display screen or a touch panel, and may collect a touch operation of a user on or near the touch-sensitive surface (such as an operation of a user on or near the touch-sensitive surface 131 by using any suitable object or attachment, such as a finger or a touch pen), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 800. The graphical user interfaces may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 8, the touch-sensitive surface 131 and the display panel 141 are used as two separate parts to implement input and output functions, in some embodiments, the touch-sensitive surface 131 and the display panel 141 may be integrated to implement the input and output functions.

The terminal 800 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 800 is moved to the ear. As one type of motion sensor, a gravity acceleration sensor may detect magnitude of accelerations at various directions (which generally are tri-axial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensors, such as a gyroscope, a barometer, a hygrometer, a thermometer, and an infrared sensor, which may be configured in the terminal 800 are not further described herein.

The audio circuit 160, a loudspeaker 161, and a microphone 162 may provide audio interfaces between the user and the terminal 800. The audio circuit 160 may transmit, to the loudspeaker 161, an electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 800.

WiFi belongs to a short distance wireless transmission technology. The terminal 800 may help, by using the WiFi module 170, a user to receive and send an e-mail, browse a webpage, access stream media, and the like, which provides wireless broadband Internet access for the user. Although FIG. 8 shows the WiFi module 170, it may be understood that, the WiFi module 170 does not belong to a necessary constitution of the terminal 800, and can be ignored according to demands without changing the scope of the essence of the present disclosure.

The processor 180 is a control center of the terminal 800, and connects to various parts of the entire mobile phone by using various interfaces and lines. By running or executing the software program and/or module stored in the memory 120, and invoking data stored in the memory 120, the processor 180 performs various functions and data processing of the terminal 800, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may also not be integrated into the processor 180.

The terminal 800 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown in the figure, the terminal 800 may further include a camera, a Bluetooth module, and the like, which are not further described herein. Specifically, in this embodiment, the display unit of the terminal is a touch screen display, and the terminal further includes a memory and one or more programs. The one or more programs are stored in the memory and configured to be executed by one or more processors. The one or more programs contain instructions used for performing the following operations: obtaining a login entry identifier of a specified login entry in a current network application, where the network application contains at least one login entry, and each login entry corresponds to one function in the network application; obtaining an interface drawing resource corresponding to the login entry identifier, where each login entry identifier corresponds to one interface drawing resource, and the interface drawing resource corresponding to each login entry identifier is used to describe a function corresponding to a login entry identified by the login entry identifier; and drawing a login interface of the specified login entry according to the interface drawing resource corresponding to the login entry identifier.

Assuming that the above description is a first possible implementation manner, in a second possible implementation manner provided based on the first possible implementation manner, the memory of the terminal further contains instructions used for performing the following operation: obtaining the interface drawing resource corresponding to the login entry identifier from local storage, or obtaining the interface drawing resource corresponding to the login entry identifier from a server.

In a third possible implementation manner provided based on the first possible implementation manner, the memory of the terminal further contains instructions used for performing the following operations: determining whether the interface drawing resource corresponding to the login entry identifier is stored locally; and performing the step of obtaining the interface drawing resource corresponding to the login entry identifier from a server if the interface drawing resource corresponding to the login entry identifier is not stored locally.

In a fourth possible implementation manner provided based on the third possible implementation manner, the memory of the terminal further contains instructions used for performing the following operation: obtaining the interface drawing resource corresponding to the login entry identifier from local storage if the interface drawing resource corresponding to the login entry identifier is stored locally.

In a fifth possible implementation manner provided based on the second or the third possible implementation manner, the memory of the terminal further contains instructions used for performing the following operations: obtaining a default interface drawing resource that is stored locally; and drawing a login interface corresponding to the specified login entry according to the default interface drawing resource, and after the interface drawing resource corresponding to the login entry identifier is downloaded, performing the step of drawing the login interface of the specified login entry according to the interface drawing resource corresponding to the login entry identifier.

In a sixth possible implementation manner provided based on the second or the third possible implementation manner, the memory of the terminal further contains instructions used for performing the following operation: storing locally the interface drawing resource corresponding to the login entry identifier.

In the terminal provided in the present disclosure, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

### Embodiment 5

This embodiment of the present invention further provides a computer readable storage medium. The computer readable storage medium may be a computer readable storage medium contained in the memory in the foregoing embodiment, or a computer readable storage medium that exists separately and is not mounted into a terminal. The computer readable storage medium stores one or more programs. The one or more programs are executed by one or more processors to implement a login interface displaying method. The method includes: obtaining a login entry identifier of a specified login entry in a current network application, where the network application contains at least one login entry, and each login entry corresponds to one function in the network application; obtaining an interface drawing resource corresponding to the login entry identifier, where each login entry identifier corresponds to one interface drawing resource, and the interface drawing resource corresponding to each login entry identifier is used to describe a function corresponding to a login entry identified by the login entry identifier; and drawing a login interface of the specified login entry according to the interface drawing resource corresponding to the login entry identifier.

Assuming that the above description is a first possible implementation manner, in a second possible implementation manner provided based on the first possible implementation manner, the obtaining an interface drawing resource corresponding to the login entry identifier includes: obtaining the interface drawing resource corresponding to the login entry identifier from local storage, or obtaining the interface drawing resource corresponding to the login entry identifier from a server.

In a third possible implementation manner provided based on the first possible implementation manner, the obtaining an interface drawing resource corresponding to the login entry identifier includes: determining whether the interface drawing resource corresponding to the login entry identifier is stored locally; and performing the step of obtaining the interface drawing resource corresponding to the login entry identifier from a server if the interface drawing resource corresponding to the login entry identifier is not stored locally.

In a fourth possible implementation manner provided based on the third possible implementation manner, after the determining whether the interface drawing resource corresponding to the login entry identifier is stored locally, the method further includes: obtaining the interface drawing resource corresponding to the login entry identifier from local storage if the interface drawing resource corresponding to the login entry identifier is stored locally.

In a fifth possible implementation manner provided based on the second or the third possible implementation manner, before the obtaining the interface drawing resource corresponding to the login entry identifier from a server, the method further includes: obtaining a default interface drawing resource that is stored locally; and drawing a login interface corresponding to the specified login entry according to the default interface drawing resource, and after the interface drawing resource corresponding to the login entry identifier is downloaded, performing the step of drawing the login interface of the specified login entry according to the interface drawing resource corresponding to the login entry identifier.

In a sixth possible implementation manner provided based on the second or the third possible implementation manner, after the obtaining the interface drawing resource corresponding to the login entry identifier from a server, the method further includes: storing locally the interface drawing resource corresponding to the login entry identifier.

In the computer readable storage medium provided in this embodiment of the present invention, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

### Embodiment 6

This embodiment of the present invention provides a graphical user interface. The graphical user interface is used in a terminal. The terminal includes a touch screen display, a memory, and one or more processors configured to execute one or more programs. The graphical user interface may implement a network application having multiple functions. The graphical user interface may provide login entries (e.g., menu options, plug-in buttons) for the multiple functions of the network application. The graphical user interface may be configured to: obtain a login entry identifier of a specified login entry in a current network application, where the network application contains at least one login entry, and each login entry corresponds to one function in the network application; obtain an interface drawing resource corresponding to the login entry identifier, where each login entry identifier corresponds to one interface drawing resource, and the interface drawing resource corresponding to each login entry identifier is used to describe a function corresponding to a login entry identified by the login entry identifier; and draw a login interface of the specified login entry according to the interface drawing resource corresponding to the login entry identifier.

In the graphical user interface provided in this embodiment of the present invention, a login entry identifier of a specified login entry in a current network application is obtained, an interface drawing resource corresponding to the login entry identifier is obtained, and a login interface of the specified login entry is drawn according to the interface drawing resource corresponding to the login entry identifier. Because different functions in the current network application correspond to different interface drawing resources, and different login interfaces are drawn, the login interface is presented in rich forms, thereby providing a desirable operating experience for a user at login.

It should be noted that, when the login interface displaying apparatus provided in the foregoing embodiment displays a login interface, description is made only through examples of division of the functional modules. In an actual application, the functions may be assigned according to needs to be implemented by different functional modules, that is, the internal structure of the apparatus is divided into different functional modules, so as to implement all or a part of the functions described above. Besides, the login interface displaying apparatus in the foregoing embodiment falls within the same conception as that of the embodiment of the login interface displaying method, and the method embodiment may serve as a reference for details of a specific implementation process thereof, which are not repeated herein.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present invention. Any modification, equivalent replacement, or improvement made within the spirit and principle of the present disclosure shall fall within the protection scope of the present disclosure.

What is claimed is:

1. A login interface displaying method, comprising:
at a terminal having one or more processors and memory storing programs executed by one or more processors;
obtaining a login entry identifier of a specified login entry in a current network application, the network application containing at least one login entry, and each login entry corresponding to one function in the network application;
obtaining an interface drawing resource corresponding to the login entry identifier, each login entry identifier corresponding to one interface drawing resource, and the interface drawing resource corresponding to each login entry identifier being used to describe a function corresponding to a login entry identified by the login entry identifier; and
drawing a login interface of the specified login entry according to the interface drawing resource corresponding to the login entry identifier.

2. The method according to claim 1, wherein the obtaining an interface drawing resource corresponding to the login entry identifier comprises:
obtaining the interface drawing resource corresponding to the login entry identifier from a local storage, or
obtaining the interface drawing resource corresponding to the login entry identifier from a server.

3. The method according to claim 1, wherein the obtaining an interface drawing resource corresponding to the login entry identifier comprises:
determining whether the interface drawing resource corresponding to the login entry identifier is stored locally; and
performing the step of obtaining the interface drawing resource corresponding to the login entry identifier from a server if the interface drawing resource corresponding to the login entry identifier is not stored locally.

4. The method according to claim 3, wherein after the determining whether the interface drawing resource corresponding to the login entry identifier is stored locally, the method further comprises:
obtaining the interface drawing resource corresponding to the login entry identifier from a local storage if the interface drawing resource corresponding to the login entry identifier is stored locally.

5. The method according to claim 2, wherein before the obtaining the interface drawing resource corresponding to the login entry identifier from the server, the method further comprises:
obtaining a default interface drawing resource that is stored locally; and
drawing a login interface corresponding to the specified login entry according to the default interface drawing resource, and after the interface drawing resource corresponding to the login entry identifier is downloaded, performing the step of drawing the login interface of the specified login entry according to the interface drawing resource corresponding to the login entry identifier.

6. The method according to claim 2, wherein after the obtaining the interface drawing resource corresponding to the login entry identifier from the server, the method further comprises:
storing locally the interface drawing resource corresponding to the login entry identifier.

7. A terminal, comprising:
one of more processors;
memory; and
one or more programs modules stored in the memory and configured for execution by the one or more processors, the one or more program modules within a login interface displaying apparatus, comprising:
a first obtaining module, configured to obtain a login entry identifier of a specified login entry in a current network application, the network application containing at least one login entry, and each login entry corresponding to one function in the network application;
a second obtaining module, configured to obtain an interface drawing resource corresponding to the login entry identifier, each login entry identifier corresponding to one interface drawing resource, and the interface drawing resource corresponding to each login entry identifier being used to describe a function corresponding to a login entry identified by the login entry identifier; and
a drawing module, configured to draw a login interface of the specified login entry according to the interface drawing resource corresponding to the login entry identifier.

8. The apparatus according to claim 7, wherein the second obtaining module comprises:
an obtaining unit, configured to obtain the interface drawing resource corresponding to the login entry identifier from a local storage, or obtain the interface drawing resource corresponding to the login entry identifier from a server.

9. The apparatus according to claim 8, wherein the second obtaining module further comprises:
a determining unit, configured to determine whether the interface drawing resource corresponding to the login entry identifier is stored locally; and
a downloading unit, configured to perform the step of obtaining the interface drawing resource corresponding to the login entry identifier from a server if the interface drawing resource corresponding to the login entry identifier is not stored locally.

10. The apparatus according to claim 9, wherein the second obtaining module further comprises:
a first obtaining unit, configured to obtain the interface drawing resource corresponding to the login entry identifier from a local storage if the interface drawing resource corresponding to the login entry identifier is stored locally.

11. The apparatus according to claim 8, wherein the second obtaining module further comprises:
a second obtaining unit, configured to obtain a default interface drawing resource that is stored locally, wherein
the drawing module is configured to draw a login interface corresponding to the specified login entry according to the default interface drawing resource, and after the interface drawing resource corresponding to the login entry identifier is downloaded, perform the step of drawing the login interface of the specified login entry according to the interface drawing resource corresponding to the login entry identifier.

12. The apparatus according to claim 8, wherein the second obtaining module further comprises:
a storing unit, configured to store locally the interface drawing resource corresponding to the login entry identifier.

13. A non-transitory computer readable storage medium having stored therein one or more instructions, which, when executed by a terminal, cause the terminal to perform:
obtaining a login entry identifier of a specified login entry in a current network application, the network application containing at least one login entry, and each login entry corresponding to one function in the network application;
obtaining an interface drawing resource corresponding to the login entry identifier, each login entry identifier corresponding to one interface drawing resource, and the interface drawing resource corresponding to each login entry identifier being used to describe a function corresponding to a login entry identified by the login entry identifier; and
drawing a login interface of the specified login entry according to the interface drawing resource corresponding to the login entry identifier.

14. The non-transitory computer readable storage medium according to claim 13, wherein obtaining an interface drawing resource corresponding to the login entry identifier comprises:
obtaining the interface drawing resource corresponding to the login entry identifier from a local storage, or
obtaining the interface drawing resource corresponding to the login entry identifier from a server.

15. The non-transitory computer readable storage medium according to claim 13, wherein obtaining an interface drawing resource corresponding to the login entry identifier comprises:
determining whether the interface drawing resource corresponding to the login entry identifier is stored locally; and
performing the step of obtaining the interface drawing resource corresponding to the login entry identifier from a server if the interface drawing resource corresponding to the login entry identifier is not stored locally.

16. The non-transitory computer readable storage medium according to claim 15, wherein after the determining whether the interface drawing resource corresponding to the login entry identifier is stored locally, the method further comprises:
obtaining the interface drawing resource corresponding to the login entry identifier from a local storage if the interface drawing resource corresponding to the login entry identifier is stored locally.

17. The non-transitory computer readable storage medium according to claim 14, wherein before the obtaining the interface drawing resource corresponding to the login entry identifier from the server, the method further comprises:
obtaining a default interface drawing resource that is stored locally; and
drawing a login interface corresponding to the specified login entry according to the default interface drawing resource, and after the interface drawing resource corresponding to the login entry identifier is downloaded, performing the step of drawing the login interface of the specified login entry according to the interface drawing resource corresponding to the login entry identifier.

18. The non-transitory computer readable storage medium according to claim 14, wherein after the obtaining the interface drawing resource corresponding to the login entry identifier from the server, the method further comprises:
storing locally the interface drawing resource corresponding to the login entry identifier.
